(19) United States
(12) Patent Application Publication
(10) Pub. No.: US 2026/0170328 A1
(43) Pub. Date: Jun. 18, 2026

(54) GENERATIVE METAMODEL FOR ACCELERATED SIMULATION MODELING

(71) Applicant: DISNEY ENTERPRISES, INC., Burbank, CA (US)

(72) Inventors: Frederick C. ZAHRN, Orlando, FL (US); Kevin Andrew HEINS, Windermere, FL (US); Wei YUAN, Orlando, FL (US); Yijun DONG, Orlando, FL (US)

(21) Appl. No.: 19/418,849

(22) Filed: Dec. 12, 2025

Related U.S. Application Data
(60) Provisional application No. 63/733,960, filed on Dec. 13, 2024.

(51) Int. Cl. G06N 3/08; G06N 3/0442

(52) U.S. Cl. CPC G06N 3/08; G06N 3/0442

(57) ABSTRACT

The present invention sets forth techniques for training a metamodel to mimic the operation of a simulation that calculates engagement values based on a quantity of services, a product type that consumes those services, a service date on which the services are to be consumed, and a time horizon of days prior to and including the service date. For each date in the time horizon, the simulation calculates an engagement value that represents the cumulative percentage of the services that is simulated to have been allocated as of that date. The metamodel infers engagement values for each date in the time horizon based on the same inputs provided to the simulation. The metamodel is iteratively trained based on differences between the simulated and inferred engagement values associated with multiple sets of inputs. The trained metamodel may require much less time and far fewer computing resources compared to the simulation.

### CROSS-REFERENCE TO RELATED APPLICATIONS

This application claims priority benefit to U.S. Provisional application titled “GENERATIVE METAMODEL FOR ACCELERATED SIMULATION MODELING,” filed on Dec. 13, 2024, and having Ser. No. 63/733,960. This related application is also hereby incorporated by reference in its entirety.

### BACKGROUND

### Field of the Various Embodiments

The present invention relates generally to simulation and machine learning and, more specifically, to a generative metamodel for accelerated simulation modeling.

### Description of the Related Art

An organization may allocate services or other resources to be shared by a variety of products. On any date, the organization's capacity to deliver services is finite, and the resources may be shared among different products that each have differing service needs and characteristics. As a result, optimally managing the availability of resources across potentially varying time horizons is a key organizational challenge. Managing service availability generally improves the quality of provided services and prevents wasting or spoilage of services that are available but not successfully allocated to one or more products that require the services. Managing service availability is further complicated by dynamic changes in either or both of service capacity and service demand.

Analytical challenges in service management include causal inference, forecasting, and optimization. Causal inference attempts to quantify the effect of a particular condition or event on service demand and/or capacity, enabling informed adjustments in response to the condition or event. Forecasting identifies and projects trends in service demand and capacity, and aids in future service allocation planning. Optimization is used to determine the best product availability, given a known set of goals and constraints.

One existing technique for managing a finite quantity of shared services includes a stochastic dynamic programming formulation. Stochastic dynamic programming incorporates uncertainty in parameter estimation, inputs, outputs, disturbances, and unknown mismatches between a model and a real-world system that the model is intended to represent. One drawback to this technique is that an environment may include multiple different products and/or offerings that require the use of the same shared services, and the different products and/or offerings may include several different kinds of interdependencies. For example, two different products may require that services be allocated in a particular order. In another example, two products may be mutually exclusive, such that services should be allocated to at most one of the two products. In general, products and the services required by those products may include many-to-many relationships. As a result, stochastic dynamic programming formulations intended to manage service allocation in a network environment of interdependent products may exhibit exponentially large and potentially unmanageable state spaces.

Other existing techniques may perform service management analysis via simulations. Simulations may be highly interpretable, and may also allow for quantification of various types of uncertainty in causal inference, forecasting, and optimization. One drawback of these techniques is that they may incur significant computational complexity based on the sequential and path-dependent nature of the process. Further, managing service capacity requires accurate representation of engagement and disengagement events, where a disengagement event describes a situation where services that were previously allocated (or forecasted to be allocated at some future time) are no longer required by an associated product. As a result, a simulation may be required to generate discrete events, including disengagement events contingent on the resolution of previous engagement events relative to availability controls. A simulation that is sophisticated enough to product useful inferences, forecasts, and/or optimizations may become overly complex, and require an unsustainable quantity of computing resources. Moreover, organizational users may need results quickly to address decision-making needs at the pace of operations, while a sufficiently accurate simulation may require hours or even days of computing time to generate results. Complexity challenges in simulations may be addressed via selection of programming languages, scaling computational power, concurrency, and algorithmic and mathematical techniques. However, these techniques may provide only temporary or incremental improvements, while the simulation continues to be bound by available computing resources.

Still other existing techniques may attempt to train a discriminative neural network-based metamodel to mimic the operation of a more complex base simulation model. Once trained on multiple paired examples of simulation inputs and outputs processed and generated by the base simulation model, the discriminative metamodel may capture relationships between the input and outputs, and may generate output metrics, such as output summary statistics, for a given set of inputs more quickly than the complex base model. One disadvantage to these discriminative metamodels is that while they may generate output summary statistics, such as a percentage of products that were successfully allocated services, or a measure of average service utilization, they may not be operable to simulate the underlying stochastic processes in the same manner as the base model. For example, the base model may generate engagement curves over a specified time horizon, where the engagement curves reveal time-varying relationships between requesting products and the shared services allocated to the products considering time-specific predicted engagement and disengagement events.

As the foregoing illustrates, what is needed in the art are more effective techniques for accurately modeling service demand and capacity over multiple time horizons.

### SUMMARY

One embodiment of the present invention sets forth a technique for training a neural network comprises determining training input associated with a base simulation model, wherein the training input includes at least a capacity metric associated with a service and a designation of a product that consumes the service. The technique includes generating, via execution of a neural network, training output based on the training input, wherein the training output comprises predictions of one or more engagement curves associated with the training input. The technique also includes training the neural network, based on one or more losses associated with (i) a first distribution associated with the training output and (ii) a second distribution associated with a simulation output of the base simulation model.

One technical advantage of the disclosed techniques relative to the prior art is that the disclosed techniques include a generative metamodel that is operable to mimic the operation of a complex base model that simulates multiple interdependent service allocation and deallocation events at speeds that enable real-time or near real-time decision making within a time-sensitive context that potentially includes limited computing resources. Further, rather than simply generating simulation output summary statistics, the generative metamodel is operable to simulate underlying stochastic processes and predict engagement curves representing the allocation and deallocation of services to products over time. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the training engine of FIG. 1, according to some embodiments.

FIG. 3 is an illustration of an engagement chart and multiple engagement curves, according to some embodiments.

FIG. 4 is a flow diagram of method steps for training a metamodel, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

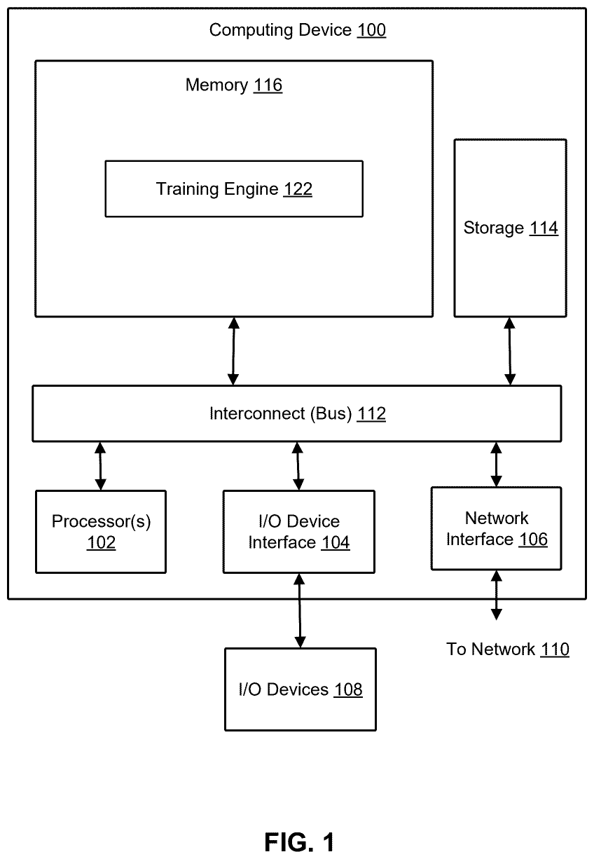

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, Augmented Reality or Mixed Reality headset, or any other type of computing device that is configured to receive input, process data, and optionally display images, and is suitable for practicing one or more embodiments. Computing device 100 is configured to run a training engine 122 that resides in a memory 116.

It is noted that the computing device described herein is illustrative and that any other technically feasible configurations fall within the scope of the present disclosure. For example, multiple instances of training engine 122 could execute on a set of nodes in a distributed and/or cloud computing system to implement the functionality of computing device 100. In another example, training engine 122 could execute on various sets of hardware, types of devices, or environments to adapt training engine 122 to different use cases or applications. In a third example, training engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122.

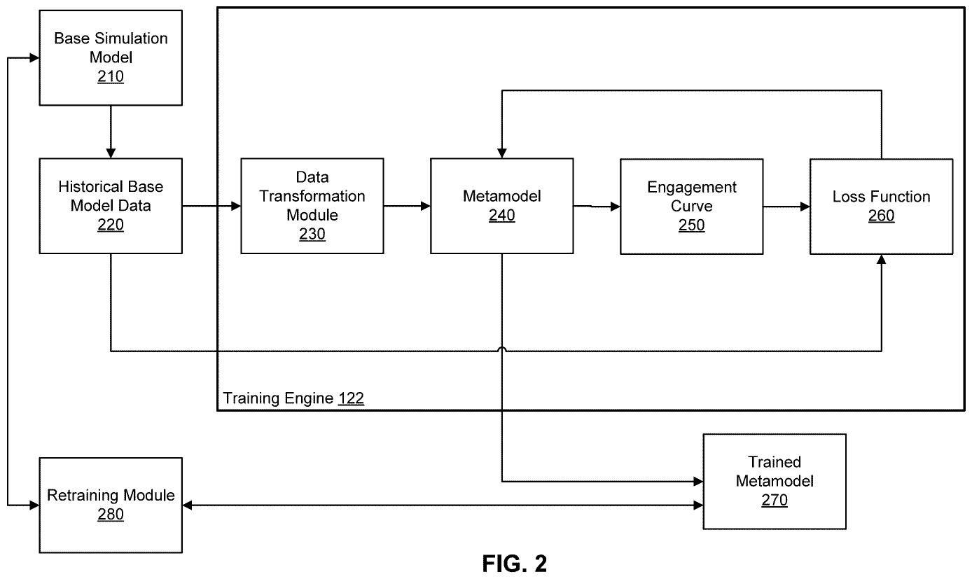

FIG. 2 is a more detailed illustration of training engine 122 of FIG. 1, according to some embodiments. Training engine 122 modifies one or more adjustable parameters included in metamodel 240 based data included in historical base model data 220 and associated with base simulation model 210. Training engine 122 generates trained metamodel 270 based on modified metamodel 240, where trained metamodel 270 mimics the operation of base simulation model 210, such as generating one or more engagement curves associated with a service over potentially varying time horizons. Training engine 122 includes, without limitation, data transformation module 230, engagement curve 250, and loss function 260. During operational deployment of trained metamodel 270, retraining module 280 may monitor and evaluate the performance of trained metamodel 270 and recommend and/or automatically initiate continued training of trained metamodel 270.

In various embodiments, base simulation model 210 generates an engagement curve associated with a specified service and one or more specified products that consume the service on a specified service date. Base simulation model 210 may generate the engagement curve by simulating multiple service allocation and deallocation events over a specified time horizon leading up to the service date, subject to one or more demand factors.

In various embodiments, a service may represent any resource, where the resource is generally finite and perishable. A finite resource may include an associated fixed capacity, such as a fixed quantity of meeting rooms that are available for reservation, a fixed quantity of seats within a particular room, or a fixed quantity of available tickets for an event. A perishable resource is a resource where unused capacity associated with one service date is not available for use on a future service date. For example, if a shared computing resource sits unused for six hours on a Monday, those six hours are effectively lost, and cannot be added to the available computing capacity associated with a future date.

In various embodiments, a product may represent anything that consumes services on one or more specified service dates. For example, hosting a seminar may require reserving a conference room from a pool of available conference rooms, or a concertgoer may purchase a ticket for a seat in a venue on a particular day.

In various embodiments, an allocation event may represent the assignment of some quantity of a service to a product or other requester on the specified service date, while a deallocation event may represent a release of services by a product or other requester, such as a cancellation of a previous service request. A deallocation event may also describe a situation where a product or other requester does not use the services allocated to it on the specified service date. For example, a hotel guest may be a “no-show” on a previously requested booking date, or a computer program that was scheduled for execution in a shared computing environment may not be ready for execution on the scheduled service date.

Allocation and deallocation events may be influenced by one or more demand factors. For example, demand for a particular service may be periodic, such that demand for the service increases or decreases based on, e.g., a season of the year or a day of the week. In various embodiments where the service incurs some type of monetary, nonmonetary, opportunity, and/or computational cost, a change in the incurred cost may affect the demand for the service. Demand factors may also include constraints related to the selection of a service date. For example, in an embodiment where a product may request a block of multiple contiguous service dates, a particular service date may not be eligible for selection as the starting date in a block of multiple contiguous service dates. Similarly, the particular service date may not be eligible for selection as the ending date in a block of multiple contiguous service dates. These restrictions may influence a product or other requestor to shorten or lengthen a requested block of service dates, or to keep the length of the block the same while shifting the starting date forward or backward in time. These example demand factors are not limiting, and other demand factors, such as various economic indicators, are contemplated.

In various embodiments, allocation and deallocation events may be subject to date-based time constraints. For example, tickets for a concert are generally made available for purchase on an advertised date prior to the date of the concert. Similarly, a hotel may not allow reservations more than one year in advance. These availability start dates determine a time horizon for the simulation and/or modeled prediction of demand and capacity associated with a specified service, where the time horizon begins on the availability start date and ends on the service date. The cumulative demand and/or available capacity associated with a specified service date may be simulated and/or predicted for any date that falls within the time horizon. For example, given a service date, a user may wish to predict what percentage of a service's capacity on that service date will have already been reserved at the end of each day included in the time horizon.

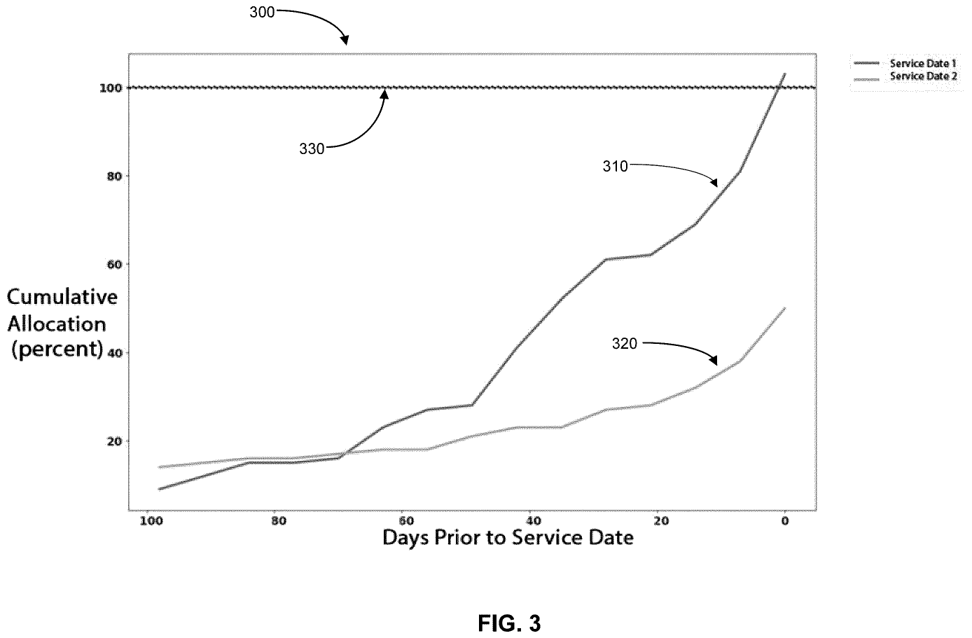

Turning now to FIG. 3, FIG. 3 is an illustration of an engagement chart and multiple engagement curves, according to some embodiments. Engagement chart 300 is associated with a specified finite and perishable service, and includes engagement curves 310 and 320 and resource constraint 330. Each of engagement curves 310 and 320 is associated with a different service date, and the x-axis of engagement chart 300 indicates a number of days prior to the specified service date, such that the “0” label on the x-axis is associated with each engagement curve's service date, i.e., “Service Date 1” for engagement curve 310 and “Service Date 2” for engagement curve 320. The y-axis of engagement chart 300 indicates a percentage of the service's capacity that has been allocated. Resource constraint 330 indicates a specified maximum available capacity for the service. Although resource constraint 330 is depicted at the 100 percent level, resource constraint 330 may appear above or below the 100% level based on explicit constraints imposed during simulation or prediction. Further, actual, simulated, and/or predicted allocation of a service may exceed the level of resource constraint 330, as depicted by the portion of engagement curve 310 that extends above resource constraint 330. For example, an instance of resource constraint 330 may include an associated allowable overallocation margin for simulated or predicted allocation values, or an actual historical allocation may exceed resource constraint 330 due to intentional and/or unintentional overallocation of a service.

As shown, each of engagement curves 310 and 320 begins approximately 100 days prior to the curve's respective service date, and ends on the curve's respective service date. The value of an engagement curve corresponding to X=0 represents an actual, simulated, or predicted utilization of the service on the requested service date, depending on the source of the data upon which the engagement curve is based. As shown, engagement curve 310 indicates that the service was, or is simulated/predicted to be, approximately 105% utilized on Service Date 1. Similarly, engagement curve 320 shows that the service utilization associated with Service Date 2 was or will be approximately 50%.

In addition to depicting an actual or simulated/predicted service utilization associated with a particular service date, an engagement curve enables the calculation of various statistical characteristics associated with the service utilization. For example, the first derivative, or slope, of an engagement curve at a point in time represents an instantaneous rate at which the service is being purchased, reserved, or otherwise allocated and made unavailable for future allocation. Similarly, the second derivative of the engagement curve at a point in time represents how quickly that instantaneous rate is changing. A difference in engagement curve values between two points in time represents a percentage of the net total available service capacity allocated between those two points in time, based on both allocation and deallocation events. The remaining capacity for a resource is established by reference to the total engagement across products consuming a given resource.

Engagement curves and associated statistical characteristics provide useful information that may inform organizational strategies related to service utilization optimization, including strategies for maximizing service utilization on a particular service date. For example, if only 35% of a service's capacity on a given service date is predicted to be allocated by the service date, then an organization or other user may attempt to influence the demand for the service by, e.g., modifying service pricing and/or nonmonetary costs, developing or expanding an advertising campaign related to the service, or offering incentives, such as discounts on future reservations for the same service or for a different service. In an example where a service is expected to be 100% allocated well before the service date, the organization may wish to increase prices or other costs associated with the service to lessen demand and/or increase revenue. Alternatively, the organization may seek to increase the service capacity on the specified service date by, e.g., temporarily increasing a number of computing assets in a shared computing environment or reconfiguring a meeting space to provide additional seating capacity.

Returning to FIG. 2, base simulation model 210 generates an engagement curve for a specified service, service capacity metric, and time horizon, based on consumption of the specified service by one or more products and subject to specified demand factors. Base simulation model 210 simulates, over a series of time steps encompassing the specified time horizon, multiple service allocation and deallocation events, where each event is associated with a particular time step. For any given time step corresponding to a point in the time horizon, base simulation model 210 may calculate the utilized service capacity based on the service capacity metric and the net cumulative results of the simulated service allocation and deallocation events during previous time steps. The calculated values for utilized service capacity at multiple points in the time horizon determine an engagement curve for the service and time horizon.

A demand factor provided as input to base simulation model 210 may include an associated time step. For example, base simulation model 210 may simulate changes to a service's pricing or other costs at various time steps within the time horizon. Similarly, a reservation restriction included in the input to base simulation model 210, such as a prohibition against a multi-day reservation beginning or ending on the specified service date, may include an associated time step within the time horizon indicating when the restriction was implemented or removed. Characteristics of the specified service may be encoded into a high-dimensionality vector input to base simulation model 210. The service capacity associated with the specified service may be encoded with the service characteristics, or provided as a separate input to base simulation model 210.

Base simulation model 210 may be preconfigured based on a dataset (not shown) that includes historical inputs and associated engagement curves. In various embodiments, the dataset may include internally generated inputs and associated engagement curves. Additionally or alternatively, the dataset may include inputs and engagement curves sourced from a specialized external repository.

In various embodiments, base simulation model 210 may incorporate uncertainty into calculated engagement curves by introducing quantifiable uncertainty into one or more inputs over multiple simulation repetitions. For example, base simulation model 210 may apply a perturbation to each of one or more input values, where the perturbation to an input value may be sampled from a defined probability distribution associated with the input value. Depending on the ranges of perturbation values associated with the simulation inputs, the complexity of any demand factors and/or reservation restrictions, and interactions between demand factors and/or reservation restrictions, base simulation model 210 may execute thousands, or tens of thousands, of simulation repetitions and record one or more of the engagement curves calculated from the simulation repetitions. In various embodiments, base simulation model 210 may record extreme upper and lower allocated service capacity values associated with each time point within the time horizon. Additionally or alternatively, base simulation model 210 may calculate and record a weighted average allocated service capacity value associated with each time point within the time horizon, and generate an average engagement curve based on the weighted averages. After generating an engagement curve, base simulation model 210 may record the generated engagement curve and the associated simulation inputs in historical base model data 220.

In various embodiments, historical base model data 220 includes engagement curves generated by base simulation model 210 and the simulation inputs associated with each engagement curve. The paired simulation inputs and corresponding simulated engagement curves stored in historical base model data 220 represent ground truth data describing the operation of base simulation model 210. During each iteration of training metamodel 240 discussed herein, historical base model data 220 transmits the simulation inputs and the corresponding simulated engagement curve to data transformation module 230. Historical base model data 220 also transmits the corresponding simulated engagement curve to loss function 260.

In various embodiments, data transformation module 230 receives simulation input data and a corresponding simulated engagement curve from historical base model data 220 and modifies the simulation input data for transmission to metamodel 240. Data transformation module 230 may generate a static embedding for a service-consuming product associated with the simulation input data so that metamodel 240 may learn the static embedding during training. By learning multiple product-specific static embeddings to be provided as an input to metamodel 240, a single instance of metamodel 240 may be operable to infer engagement values for a variety of products across multiple locations and/or organizations, obviating the need to train a separate metamodel for each of multiple products.

Data transformation module 230 may also extract engagement values from the simulated engagement curve that are associated with times prior to an “as of” date included in the time horizon. While training metamodel 240, training engine 122 may randomly choose a date within the time horizon for the “as of” date. By choosing a date within the time horizon and extracting engagement values for times prior to that date, training engine 122 may train metamodel 240 to predict engagement curve values for dates between the chosen date and the service date, given engagement curve values for dates prior to the chosen date. During subsequent inference operations, the “as of” date and any known engagement values prior to the “as of” date may be provided as inputs to metamodel 240. In various embodiments, the “as of” date may equivalently be expressed as a quantity of “days prior” to the service date.

Data transformation module 230 may transform simulation inputs and/or other values to values that are included in one or more predetermined numerical ranges. For example, data transformation module 230 may transform simulation inputs to a range [−1,1]. Data transformation module 230 may transform an inventory value to a range of [0,1], where the inventory value represents a remaining quantity of unallocated services, such as conference rooms, concert tickets, or CPU-hours of shared computing resources. Data transformation module 230 may transform a cumulative percentage of allocated services to a range of [−1,1], and may transform a sellout probability to a range of [0,1] representing a likelihood that all of the specified services will be allocated by the service date. In various embodiments where metamodel 240 performs multiple inferences on a set of input data that includes uncertainty, data transformation module 230 may also initialize minimum and maximum values for service utilization on the service date and record the minimum and maximum values across the multiple inferences. In these embodiments, data transformation module 230 may also add noise to one or more inputs to reflect the uncertainty in the input values. As with base simulation model 210, the noise may be sampled from a specified probability distribution.

Data transformation module 230 may also initialize a product-specific variance-covariance matrix representing relationships between various simulation inputs. In various embodiments, data transformation module 230 may also retrieve historical product-specific variance values associated with reservations (allocations) and cancellations (deallocations). Data transformation module 230 may initialize features to represent service demand, and retrieve demand factors and associated time steps from the simulation inputs. As discussed herein, demand factors may include initial pricing and price changes, restrictions on beginning and ending dates for multi-day reservations, and/or advertising efforts.

In various embodiments, data transformation module 230 may partition historical base model data 220 into training, test, and validation datasets to facilitate training and evaluating metamodel 240. Data transformation module 230 may also format inputs to metamodel 240 depending on the implementation and/or architecture. For example, in embodiments where metamodel 240 is implemented as a TensorFlow network, data transformation module 230 may serialize model inputs for transmission to metamodel 240.

In various embodiments, metamodel 240 includes a generative machine learning model, such as a Long Short Term Memory (LSTM) neural network, that is trained to mimic the operation of base simulation model 210 and generate engagement curves associated with a specified service date, a specified time horizon, and an optional “days prior” value. For one or more days included in the time horizon, metamodel 240 may predict a cumulative percentage of allocated services associated with each of the one or more days and generate the engagement curve based on the predictions. In an instance where the input to metamodel 240 includes a “days prior” value, a user may provide known or projected engagement data associated each day from the beginning of the time horizon to a date calculated from the specified service date and the “days prior” value. Metamodel 240 may then predict engagement values for each of the days from the calculated date to the specified service date, based on the user-provided engagement values. In an instance where in the input to metamodel 240 does not include a “days prior” value, metamodel 240 may predict engagement values for each day in the time horizon, including the specified service date.

While base simulation model 210 may calculate engagement values by simulating a number of allocation and deallocation events over many time steps within a time horizon, subject to complex demand factors and other inputs, these simulations are computationally complex and expensive in terms of computing resources. As a result, base simulation model 210 may require several hours to generate an engagement curve for a given scenario. After training, metamodel 240 predicts per-day engagement values from model inputs, without the need to simulate every event and/or influence that contributed to the generated engagement values. In various embodiments, metamodel 240 may generate an engagement curve approximately 100 times faster than the simulation model that it is mimicking, reducing the required time from hours to minutes, or even seconds. This decreased curve generation time enables users to quickly model multiple “what if” scenarios to inform operational decisions, such as whether to implement demand controls, or whether to temporarily increase service capacity for a specified service date.

In a non-limiting embodiment where metamodel 240 is implemented as a TensorFlow network that accepts tensor-valued inputs, metamodel 240 may include one or more input layers that are connected to the inputs of one or more tile operations. The tile operations may repeat tensor input elements along specified dimensions, aligning the dimensionality of different input tensors for subsequent operations. Metamodel 240 may also include multiple concatenation layers and multiple (e.g., 4) LSTM layers. The use of multiple LSTM layers enables metamodel 240 to process variable length inputs, such as varying time horizon lengths, without the need to pad input values to a fixed length. Metamodel 240 may include a Rectified Linear Unit (ReLU) in the final layer to improve the metamodel's ability to learn complex patterns while avoiding vanishing gradients during training. The ReLU may also improve the ability of metamodel 240 to respect resource constraints. The output of metamodel 240 includes a predicted engagement value associated with a time included in the time horizon. In various embodiments, the engagement value may include a cumulative percentage of services that are allocated, or an absolute quantity of remaining (i.e., unallocated) services. Based on the predicted engagement values, metamodel 240 generates engagement curve 250 and transmits engagement curve 250 to loss function 260.

In various embodiments, loss function 260 receives engagement curve 250 from metamodel 240 and a corresponding ground truth engagement curve from historical base model data 220. Loss function 260 calculates a loss value that represents a difference between engagement curve 250 and the corresponding ground truth engagement curve. In various embodiments, loss function 260 may include a Maximum Mean Discrepancy (MMD) loss function. The MMD loss function evaluates the two engagement curves as distributions of values over a domain, specifically distributions of engagement values over a time horizon.

Training engine 122 may iteratively modify one or more adjustable parameters included in metamodel 240 based on the loss calculated by loss function 260. Training engine 122 may continue to modify the adjustable parameters for a predetermined number of epochs, or until the calculated loss value is below a predetermined threshold. After training is complete, training engine 122 outputs modified metamodel 240 as trained metamodel 270.

In various embodiments, trained metamodel 270 infers engagement values and generates engagement curves in the same manner as described herein with respect to metamodel 240. Trained metamodel 270 receives operational scenario inputs including a learned static embedding representing a specific service-consuming product, a service date, a time horizon length, an optional “days prior” value, and features representing product demand factors and times associated with each of the demand factors. In an instance where trained metamodel 270 receives a “days prior” value, the input may also include user-provided engagement data associated with dates from the beginning of the time horizon to a date determined by the “days prior” value and the service date. Trained metamodel generates an engagement curve based on the operational scenario inputs, such as the engagement curves depicted in FIG. 3.

In various embodiments, retraining module 280 may monitor and evaluate the operation of trained metamodel 270 after trained metamodel 270 has been deployed in an operational environment, and may initiate automatic or human-directed retraining based on the monitoring and/or evaluation. During the monitoring and evaluation, retraining module 280 may analyze both the operational scenario inputs provided to trained metamodel 270 and the outputs generated by trained metamodel 270. For example, retraining module 280 may monitor operational scenario inputs provided to trained metamodel 270 and determine whether operational scenario inputs associated with a particular resource-consuming product differ significantly from scenario inputs upon which trained metamodel 270 was previously trained. For given operational scenario inputs provided to trained metamodel 270, retraining module 280 may also transmit the inputs to base simulation model 210 and evaluate differences between the outputs generated by trained metamodel 270 and the outputs generated by base simulation model 210. Retraining module 280 may perform one or more aspects of the monitoring, evaluation, and/or retraining automatically, according to a predetermined schedule of time or usage, and/or when requested by a user or by an upstream software application.

Retraining module 280 may monitor operational scenario inputs provided to trained metamodel 270 and identify a particular resource-consuming product associated with the operational scenario inputs. Retraining module 280 may compare the operational scenario inputs to training inputs that are included in historical base model data 220 and associated with the same resource-consuming product. Based on the comparison, retraining module 280 may determine whether an operational scenario input represents a material drift in the distribution of simulation inputs relative to the historical scenario inputs used during training. In various embodiments, retraining module 280 may perform individual comparisons between the operational scenario input and one or more historical scenario inputs included in historical base model data 220 based on, e.g., a calculated Mahalanobis distance or a K-L divergence measurement between the operational scenario input and a historical scenario input. Alternatively or additionally, retraining module 280 may compare the operational scenario input to an average historical scenario input calculated based on multiple historical scenario inputs, or may compare the values of individual elements included in the operational scenario input to value ranges computed from instances of the elements included in the historical scenario inputs. In various embodiments, operational scenario inputs may include elements that come from one or more of, e.g., system forecasts, baseline or optimized system controls, system-generated scenario attributes, or user-requested scenario attributes.

In an instance where retraining module 280 determines that the operational input represents an out-of-domain condition or material shift, retraining module 280 may generate an alert that includes the operational scenario input and an indication that trained metamodel 270 may benefit from continued training in response to the operational input scenario. Additionally or alternatively, retraining module 280 may automatically initiate the retrieval of relevant recent training samples and/or initiate the generation of additional training data based on the operational scenario input data. Retraining module 280 may also automatically initiate continued training of trained metamodel 270. For example, retraining module 280 may generate additional training scenario inputs similar to the operational input scenario by modifying values associated with one or more elements included in the operational input scenario. Retraining module 280 may generate additional training scenario inputs by randomly sampling a value to be applied to an element from a predetermined distribution associated with the element, or may apply one of one or more predetermined fixed values associated with the element. Retraining module 280 may transmit the additional training scenario inputs to base simulation model 210 and direct base simulation model 210 to generate corresponding engagement curves for each of the additional training scenario inputs. Base simulation model 210 may store the additional training scenario inputs and corresponding engagement curves in historical base model data 220. Retraining module 280 may automatically initiate continued training of trained metamodel 270 based on the additional training scenario inputs and corresponding engagement curves. During continued training, retraining module 280 may also incorporate historical training scenario inputs and corresponding engagement curves for historical training scenario inputs that are included in historical base model data 220, where the historical training scenario inputs exhibit at least a predetermined threshold similarity to the operational input scenario.

Retraining module 280 may also evaluate the output of trained metamodel 270 automatically, according to a predetermined schedule of time or usage, or when requested by a user or upstream software application. During operation of trained metamodel 270, trained metamodel 270 and/or retraining module 280 may record operational scenario inputs provided to trained metamodel 270 and store the operational scenario inputs in, e.g., storage 114 or historical base model data 220. Retraining module 280 may select and retrieve a recent instance of operational scenario inputs provided to trained metamodel 270, and transmit the selected operational scenario inputs to base simulation model 210 and trained metamodel 270. Retraining module 280 may direct both base simulation model 210 and trained metamodel 270 to process the selected instance of operational scenario inputs and generate simulation outputs and model outputs, respectively. In various embodiments, the recency of operational scenario inputs may be determined based on an amount of elapsed time and/or a quantity of inputs that have been processed since trained metamodel 270 processed the operational scenario. For example, recent instances of operational scenario inputs may include the previous 100 processed operational scenario inputs, and/or all operational scenario inputs processed in the previous 30 days.

After trained metamodel 270 processes the selected operational scenario inputs, retraining module 280 may retrieve and store the model outputs generated by trained metamodel 270. Similarly, after base simulation model 210 has processed the selected operational scenario inputs, retraining module 280 may retrieve and store the simulation outputs generated by base simulation model 210. The operation of retraining module 280 does not block trained metamodel 270, and trained metamodel 270 may continue to process additional operational scenario inputs while retraining module 280 waits for base simulation model 210 to finish generating simulation outputs.

In an instance where retraining module 280 is requested to evaluate trained metamodel 270 by a user or an upstream software application, the request to evaluate trained metamodel 270 may include scenario inputs provided by the user or upstream software application. Retraining module 280 may cause trained metamodel 270 and base simulation model 210 to process the provided scenario inputs as discussed above and transmit the generated and simulated outputs, respectively, to retraining module 280.

Retraining module 280 may evaluate trained metamodel 270 based on the engagement curves generated by and received from base simulation model 210 and trained metamodel 270. In various embodiments, retraining module 280 may compute a loss function value based on the engagement curves as discussed in the description of loss function 260 above. Additionally or alternatively, retraining module 280 may calculate a measure of similarity between the engagement curves using any suitable measurement technique, such as measuring a vertical distance between the two engagement curve values at multiple points along the time horizon and calculating an arithmetical mean of the distances, calculating a Hausdorff distance between the curves, and/or calculating a Fréchet distance between the curves.

Retraining module 280 may compare the computed loss function value and/or one or more of the calculated distances against a history of similar measurements taken from pairs of engagement curves included in historical base model data 220. For example, retraining module 280 may compare the loss value or distance to a historical mean associated with similar measurements, and may further determine a number of standard deviations of the historical mean by which the loss value or distance exceeds the historical mean.

Retraining module may compare the computed loss value and/or one or more of the calculated distances to one or more predetermined difference thresholds, where the predetermined thresholds may be expressed in the same units as the computed loss or distance values, or may be expressed in terms of a number of standard deviations by which the computed loss or distance value differs from an associated historical mean value. If a loss and/or a distance exceeds an associated difference threshold, retraining module 280 may generate an alert to a user or a downstream software application. The alert may include a notice that the domain of user-requested scenarios may be changing, the distribution of demand and/or capacity may be changing, or that trained metamodel 270 may not accurately model one or more aspects of the user-requested operational scenarios or the demand/capacity distributions. The alert may also include the scenario inputs, the corresponding simulated/predicted engagement curves, and/or one or more of the computed loss or distance values. The alert may suggest performing continued training on trained metamodel 270 based on recent training samples similar to the included scenario inputs. In various embodiments, retraining module 280 may also automatically retrieve relevant recent training scenario samples and/or generate additional training scenario inputs based on the included scenario inputs. Based on the retrieved and/or generated scenario inputs, retraining module 280 may automatically initiate continued training of trained metamodel 270, as discussed above.

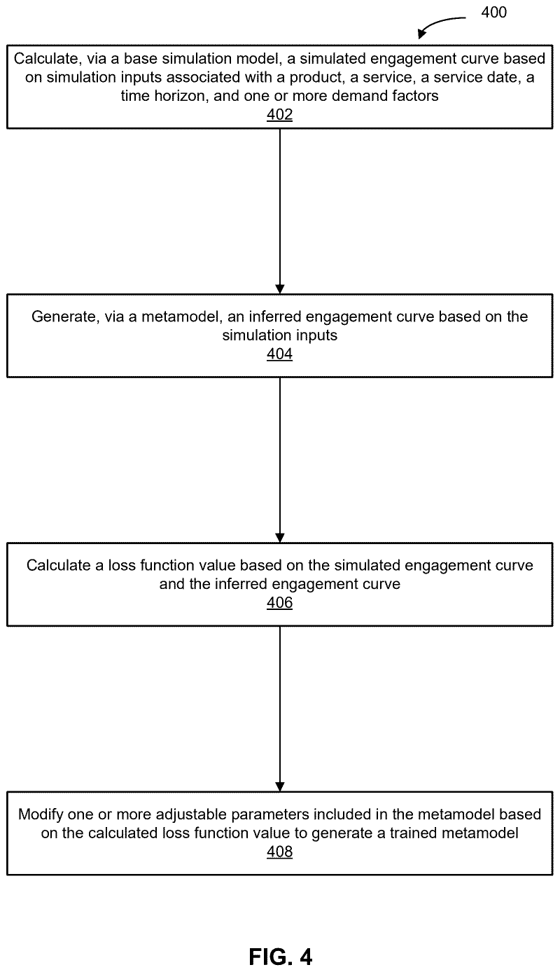

FIG. 4 is a flow diagram of method steps for training a metamodel, according to some embodiments. Although the method steps are described in conjunction with the systems of FIGS. 1 and 2, persons skilled in the art will understand that any system configured to perform the method steps in any order falls within the scope of the present disclosure.

As shown, in step 402 of method 400, base simulation model 210 calculates a simulated engagement curve based on simulation inputs associated with a product, a service, a service date, a time horizon, and one or more demand factors. A service may include any perishable resource having a finite capacity or inventory, such as a quantity of available conference rooms, an available quantity of seats within a particular conference room, or CPU-hours of processing capacity in a shared computing environment. A product may include any requesting entity or event that consumes services, such as a meeting that requires a conference room, a computer program that requires processing capacity, or a traveler who requests a hotel room. A service date represents a specific date on which the product is to consume the service, and a time horizon includes a specified number of days leading up to the service date during which products may reserve services on the service date.

A simulated engagement curve depicts, for each date in the time horizon, a simulated engagement value representing an amount of the service, such as a percentage of the service inventory, that has been allocated to one or more products as of that date. For example, a date that is four days prior to the service date and includes an associated simulated engagement value of 80% means that four days prior to the service date, 80% of the services associated with the service date will have already been allocated to one or more products. Base simulation model 210 calculates the simulated engagement curve by simulating, over multiple time steps within the time horizon, allocation events and deallocation events, where an allocation event represents a product reserving a quantity of available services on the service date. Deallocation events represent a cancellation of previously allocated services on the service date. For each day within the time horizon, the net cumulative effects of all previous allocation and deallocation events determine the simulated engagement value for that day. Historical base model data 220 includes multiple pairings of simulation input data and corresponding simulated engagement curves that collectively represent ground truth data describing the operation of base simulation model 210.

The one or more demand factors may include conditions or events that influence the demand for the service by the product. Each of the demand factors may also include an associated time within the time horizon. For example, at a specified time within the time horizon, a pricing change may influence the demand for the service. Similarly, a demand factor and associated date may specify a restriction on allocations of services to the product on the service date, such as a requirement that requests for services that span multiple days and include the service date cannot begin on the service date.

In step 404, metamodel 240 of training engine 122 generates an inferred engagement curve based on the simulation inputs used by base simulation model 210 to calculate the simulated engagement curve. Metamodel 240, after training, mimics the operation of base simulation model 210 while requiring far fewer computing resources and much less time to generate an engagement curve compared to base simulation model 210. Metamodel 240 may include a Long Short Term Memory (LSTM) neural network operable to infer an engagement curve based on the same simulation inputs processed by base simulation model 210.

In step 406, loss function 260 of training engine 122 calculates a loss function value based on the simulated engagement curve and the inferred engagement curve. In various embodiments, loss function 260 may include a Maximum Mean Discrepancy (MMD) loss function. The MMD loss function evaluates the simulated and inferred engagement curves as distributions of engagement values over a domain that includes the time horizon, and generates the loss function value quantifying differences between the two engagement curves.

In step 408, training engine 122 modifies one or more adjustable parameters included in metamodel 240 based on the calculated loss function value to generate trained metamodel 270. Training engine 122 may iteratively modify the adjustable parameters based on calculated loss function values associated with multiple different simulated engagement curves calculated by base simulation model 210 and corresponding inferred engagement curves generated by metamodel 240. Training engine 122 may continue to modify adjustable parameters included in metamodel 240 for a predetermined number of epochs, or until the calculated loss value is below a predetermined threshold. After training is complete, trained metamodel 270 is operable to generate inferred engagement curves based on inputs associated with a product, a service, a service date, a time horizon, and one or more demand factors.

In various embodiments, both base simulation model 210 and trained metamodel 270 may be operable to incorporate uncertainty into the simulated or inferred engagement curves by executing multiple repetitions of simulation or inference while adding noise to one or more inputs during each repetition. The noise added to an input during a repetition may be randomly sampled from a predetermined probability distribution associated with the input. The resulting simulated or inferred engagement curves may represent maximum and minimum engagement values associated with each day included in the time horizon and provide an indication of quantified uncertainty in the engagement curves.
1. In some embodiments, a computer-implemented method for training a neural network comprises determining training input associated with a base simulation model, wherein the training input includes at least a capacity metric associated with a service and a designation of a product that consumes the service, generating, via execution of a neural network, training output based on the training input, wherein the training output comprises predictions of one or more engagement curves associated with the training input, and training the neural network, based on one or more losses associated with (i) a first distribution associated with the training output and (ii) a second distribution associated with a simulation output of the base simulation model.
2. The computer-implemented method of clause 1, wherein training the neural network causes the neural network to mimic an operation of the base simulation model.
3. The computer-implemented method of clauses 1 or 2, wherein the training input further includes a service date on which the product is to consume the service, and a time horizon that includes the service date and one or more dates prior to the service date.
4. The computer-implemented method of any of clauses 1-3, wherein the neural network includes a trained neural network, further comprising generating, via execution of the trained neural network, a first additional engagement curve based at least on an inference input, generating, via execution of the base simulation model, a second additional engagement curve based at least on the inference input, calculating one or more evaluation losses or evaluation distances based at least on the first additional engagement curve and the second additional engagement curve, and generating an alert based at least on a comparison of the one or more evaluation losses or evaluation distances to one or more predetermined thresholds, wherein the alert includes a recommendation to perform continued training on the trained neural network.
5. The computer-implemented method of any of clauses 1-4, wherein the generating the first additional engagement curve and the second additional engagement curve are performed according to a predetermined schedule or in response to a request from a user or an upstream software application.
6. The computer-implemented method of any of clauses 1-5, wherein the neural network includes a trained neural network, further comprising receiving input to the trained neural network, including an operational scenario input, retrieving one or more historical scenario inputs, wherein each historical scenario input exhibits at least a threshold similarity to the operational scenario input, determining at least a threshold amount of input drift associated with the operational scenario input, based at least on one or more comparisons between the operational scenario input and the one or more historical scenario inputs, and based on the determination, generating or retrieving one or more training scenario inputs and automatically initiating continued training of the trained neural network.
7. The computer-implemented method of any of clauses 1-6, further comprising adding a value to an element included in the training input, wherein the value added to the element is randomly sampled from a probability distribution associated with the element.
8. The computer-implemented method of any of clauses 1-7, wherein the service is perishable and the capacity metric associated with the service is finite.
9. The computer-implemented method of any of clauses 1-8, wherein the training input includes one or more demand factors associated with the service.
10.The computer-implemented method of any of clauses 1-9, wherein the one or more demand factors include a price change associated with the service or a date-based restriction on a consumption of the service by the product.
11.In some embodiments, one or more non-transitory computer-readable media store instructions that, when executed by one or more processors, cause the one or more processors to perform the steps of determining training input associated with a base simulation model, wherein the training input includes at least a capacity metric associated with a service and a designation of a product that consumes the service, generating, via execution of a neural network, training output based on the training input, wherein the training output comprises predictions of one or more engagement curves associated with the training input, and training the neural network, based on one or more losses associated with (i) a first distribution associated with the training output and (ii) a second distribution associated with a simulation output of the base simulation model.
12.The one or more non-transitory computer-readable media of clause 11, wherein training the neural network causes the neural network to mimic an operation of the base simulation model.
13.The one or more non-transitory computer-readable media of clauses 11 or 12, wherein the training input further includes (i) a service date on which the product is to consume the service and (ii) a time horizon that includes the service date and one or more dates prior to the service date.
14.The one or more non-transitory computer-readable media of any of clauses 11-13, wherein an engagement curve included in the one or more engagement curves depicts a cumulative portion of the capacity metric allocated to the product over a period of time.
15.The one or more non-transitory computer-readable media of any of clauses 11-14, wherein the neural network is a generative neural network comprising one or more Long Short Term Memory (LSTM) layers.
16.The one or more non-transitory computer-readable media of any of clauses 11-15, further comprising adding a value to an element included in the training input, wherein the value added to the element is randomly sampled from a probability distribution associated with the element.
17.The one or more non-transitory computer-readable media of any of clauses 11-16, wherein at least one of the one or more engagement curves depicts uncertainty based on the value added to the element.
18.In some embodiments, a system comprises one or more memories storing instructions, and one or more processors for executing the instructions to determine training input associated with a base simulation model, wherein the training input includes at least a capacity metric associated with a service and a designation of a product that consumes the service, generate, via execution of a neural network, training output based on the training input, wherein the training output comprises predictions of one or more engagement curves associated with the training input, and train the neural network, based on one or more losses associated with (i) a first distribution associated with the training output and (ii) a second distribution associated with a simulation output of the base simulation model.
19.The system of clause 18, wherein the one or more losses include a Maximum Mean Discrepancy (MMD) loss that quantifies differences between the first distribution and the second distribution.
20.The system of clauses 18 or 19, wherein the second distribution is based at least on cumulative effects associated with one or more simulated service allocation or deallocation events. Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a neural network, comprising:
determining training input associated with a base simulation model, wherein the training input includes at least a capacity metric associated with a service and a designation of a product that consumes the service;
generating, via execution of a neural network, training output based on the training input, wherein the training output comprises predictions of one or more engagement curves associated with the training input; and
training the neural network, based on one or more losses associated with (i) a first distribution associated with the training output and (ii) a second distribution associated with a simulation output of the base simulation model.

2. The computer-implemented method of claim 1, wherein training the neural network causes the neural network to mimic an operation of the base simulation model.

3. The computer-implemented method of claim 1, wherein the training input further includes a service date on which the product is to consume the service, and a time horizon that includes the service date and one or more dates prior to the service date.

4. The computer-implemented method of claim 1, wherein the neural network includes a trained neural network, further comprising:
generating, via execution of the trained neural network, a first additional engagement curve based at least on an inference input;
generating, via execution of the base simulation model, a second additional engagement curve based at least on the inference input;
calculating one or more evaluation losses or evaluation distances based at least on the first additional engagement curve and the second additional engagement curve; and
generating an alert based at least on a comparison of the one or more evaluation losses or evaluation distances to one or more predetermined thresholds, wherein the alert includes a recommendation to perform continued training on the trained neural network.

5. The computer-implemented method of claim 4, wherein the generating the first additional engagement curve and the second additional engagement curve are performed according to a predetermined schedule or in response to a request from a user or an upstream software application.

6. The computer-implemented method of claim 1, wherein the neural network includes a trained neural network, further comprising:
receiving input to the trained neural network, including an operational scenario input;
retrieving one or more historical scenario inputs, wherein each historical scenario input exhibits at least a threshold similarity to the operational scenario input;
determining at least a threshold amount of input drift associated with the operational scenario input, based at least on one or more comparisons between the operational scenario input and the one or more historical scenario inputs; and
based on the determination, generating or retrieving one or more training scenario inputs and automatically initiating continued training of the trained neural network.

7. The computer-implemented method of claim 1, further comprising adding a value to an element included in the training input, wherein the value added to the element is randomly sampled from a probability distribution associated with the element.

8. The computer-implemented method of claim 1, wherein the service is perishable and the capacity metric associated with the service is finite.

9. The computer-implemented method of claim 1, wherein the training input includes one or more demand factors associated with the service.

10. The computer-implemented method of claim 9, wherein the one or more demand factors include a price change associated with the service or a date-based restriction on a consumption of the service by the product.

11. One or more non-transitory computer-readable media storing instructions that, when executed by one or more processors, cause the one or more processors to perform the steps of:
determining training input associated with a base simulation model, wherein the training input includes at least a capacity metric associated with a service and a designation of a product that consumes the service;
generating, via execution of a neural network, training output based on the training input, wherein the training output comprises predictions of one or more engagement curves associated with the training input; and
training the neural network, based on one or more losses associated with (i) a first distribution associated with the training output and (ii) a second distribution associated with a simulation output of the base simulation model.

12. The one or more non-transitory computer-readable media of claim 11, wherein training the neural network causes the neural network to mimic an operation of the base simulation model.

13. The one or more non-transitory computer-readable media of claim 11, wherein the training input further includes (i) a service date on which the product is to consume the service and (ii) a time horizon that includes the service date and one or more dates prior to the service date.

14. The one or more non-transitory computer-readable media of claim 11, wherein an engagement curve included in the one or more engagement curves depicts a cumulative portion of the capacity metric allocated to the product over a period of time.

15. The one or more non-transitory computer-readable media of claim 11, wherein the neural network is a generative neural network comprising one or more Long Short Term Memory (LSTM) layers.

16. The one or more non-transitory computer-readable media of claim 11, further comprising adding a value to an element included in the training input, wherein the value added to the element is randomly sampled from a probability distribution associated with the element.

17. The one or more non-transitory computer-readable media of claim 16, wherein at least one of the one or more engagement curves depicts uncertainty based on the value added to the element.

18. A system comprising:
one or more memories storing instructions; and
one or more processors for executing the instructions to:
determine training input associated with a base simulation model, wherein the training input includes at least a capacity metric associated with a service and a designation of a product that consumes the service;
generate, via execution of a neural network, training output based on the training input, wherein the training output comprises predictions of one or more engagement curves associated with the training input; and
train the neural network, based on one or more losses associated with (i) a first distribution associated with the training output and (ii) a second distribution associated with a simulation output of the base simulation model.

19. The system of claim 18, wherein the one or more losses include a Maximum Mean Discrepancy (MMD) loss that quantifies differences between the first distribution and the second distribution.

20. The system of claim 18, wherein the second distribution is based at least on cumulative effects associated with one or more simulated service allocation or deallocation events.
